(19) United States
(12) Patent Application Publication
(10) Pub. No.: US 2006/0161690 A1
(43) Pub. Date: Jul. 20, 2006

(54) Remote device configuration automation

(76) Inventors: John Kavanagh, Palo Alto, CA (US); Donald J. Hejna JR., Menlo Park, CA (US); Andrew Bennett, Milpitas, CA (US); Niall Carter Giggins, Wood Green (GB)

Correspondence Address: JAMES D IVEY, 3025 TOTTERDELL STREET, OAKLAND, CA, 94611-1742, US

(21) Appl. No.: 11/039,646

(22) Filed: Jan. 19, 2005

(51) Int. Cl. G06F 3/00

(52) U.S. Cl. 710/5

(57) ABSTRACT

A remote control device tries each of a number of command sets and detects a user's response to each attempt to identify the correct command set. Each attempt includes sending a signal to a controlled device that, if properly received and understood by the controlled device, would cause the controlled device to display a message to the user instruction the user to perform a predetermined user input gesture on the remote control device. The remote control device recognizes the predetermined user input gesture, e.g., pushing of a button, as acknowledgment from the controlled device that the most recently sent command or commands were successfully received and understood by the controlled device.

### FIELD OF THE INVENTION

This invention relates to the field of remotely controlled electronic devices, and more specifically to a system for automating configuration of remote control units for operation with a particular controlled device.

### BACKGROUND

Remote control units are frequently designed to control devices of various, different manufacturers. For example, a digital satellite system (DSS) remote control can be designed to control not only the accompanying DSS receiver but also an attached television and a number of audiovisual devices such as digital video disk (DVD) players for example. Remote control units capable of controlling multiple devices from multiple manufacturers are sometimes referred to as universal remote controls.

One of the disadvantages of universal remote controls is their difficulty in programming, i.e., the proper configuration of the universal remote control. For example, when a user presses a “Play” button on the universal remote control, the universal remote control sends an infrared (IR) code which is interpreted by a specific playback device as a “Play” command. The particular code which represents a “Play” command varies across various models, types and manufacturers of playback devices. Thus, to send the proper code representing a “Play” command, one of a number of command sets must be selected and specified by the user.

Some universal remote controls are said to “learn” IR codes. These universal remote controls record IR codes from other remote controls which are known by the user to be operative, i.e., to successfully communicate IR codes as commands to a controlled device of interest to the user. Programming learning universal remote controls is an arduous task.

Most universal remote controls today require that the user enter a numeric code corresponding to the manufacturer and model of the controlled device. Each code identifies a complete set of commands recognized by one or more types of controlled devices. For some manufactures, only one code—and therefore only one set of command signals—is used for all models of controlled devices and identifying that code in the programming process is sufficient to properly program the universal remote control to control any model of controlled device of that manufacturer. However, other manufacturers can use as many as twenty (20) distinct codes for various models of controlled devices. In such cases, programming requires entering each of the codes individually and testing the controllability of the controlled device with the remote control so programmed. In short, to properly program a universal remote control to control a device of a manufacturer that uses twenty different codes in various models of devices can require programming the universal remote control twenty times.

Even programming the universal remote control once can be a difficult task for a user without extensive device programming experience. Such programming frequently requires pressing multiple buttons simultaneously or in sequence and/or holding a button pressed for an extended period of time (e.g., two to five full seconds) until an acknowledgment signal is sent indicating that a programming mode of the universal remote control has been entered. Such an acknowledgment signal can be a sequence of LED flashes. Once in programming mode, buttons representing a sequence of numbers are pressed by the user and followed by a button press to indicate completion of programming. Even for entering a single IR code, this is a fairly complex task for a user who just wants to watch a movie. To enter as many as twenty codes, this programming process is quite complex and time consuming.

What is needed is a simpler and easier way for a user to program a universal remote control to operate with a remotely controlled device.

### SUMMARY OF THE INVENTION

In accordance with the present invention, a remote control device tries each of a number of command sets and detects a user's response to each attempt to identify the correct command set. Each attempt includes sending a signal to a controlled device that, if properly received and understood by the controlled device, would cause the controlled device to display a message to the user instruction the user to perform a predetermined user input gesture on the remote control device. The remote control device recognizes the predetermined user input gesture, e.g., pushing of a button, as acknowledgment from the controlled device that the most recently sent command or commands were successfully received and understood by the controlled device.

The controlled device can be a DVD player and the message instructing the user is stored as content on a DVD which is authored to serve as an initial configuration DVD. When inserted into the DVD player for playback, the DVD player can first play a message instructing the user to select a manufacturer of the DVD player on the remote control device. The remote control device includes some display and self-contained user interaction capability whereby the user can specify a manufacturer of DVD players interacting solely with the remote control device.

This interaction serves primarily two purposes. First, identifying the manufacturer of the DVD player significantly limits the number of possible command sets from over one hundred to fewer than about twenty and perhaps even only one. Second, the interaction confirms to the remote control device that the DVD player is playing content from the initial configuration DVD and is ready to receive commands from the remote control device.

Alternatively, the specification of the manufacturer can be omitted altogether. Generally, all models of DVD players from all manufacturers use one of about thirty (30) unique command sets. Thus, automatic programming of a remote control device can be largely simplified without significant delay in the programming process by considering all thirty (30) of the possible command sets.

Armed with a collection of a few command sets which are candidates for effective control of the DVD player of interest, the remote control device issues a command to cause the DVD player to play a next piece of content from the initial configuration DVD according to each of the candidate command sets. If the initial message instructing the user to select the manufacturer of the DVD player within the remote control device includes a graphical user interface (GUI) button on which focus is placed, the command to play the next piece of content can be as simple as an “Enter” command, i.e., the signal typically sent by a conventional remote control when an “Enter” button is pressed on the remote control.

If the candidate command sets include the appropriate command set for the DVD player, the remote control device eventually sends an “Enter” command which is received and understood by the DVD player. However, the remote control device includes no feedback connection from the DVD player and has no way to determine that any of the sent commands are received and understood by the DVD player.

Accordingly, the next piece of content played from the initial configuration DVD includes an instruction to the user to perform a predetermined user input gesture such as pressing a button on the remote control device. Accordingly, the user provides the missing feedback channel to the remote control device. After each attempted signal, the remote control device waits for a predetermined period of time for the user to read the instruction and to perform the user input gesture. Failure of the user to perform the user input gesture within the predetermined period of time is recognized by the remote control device as an indication that the most recently attempted signal was not successfully received and understood by the DVD player. Performance of the user input gesture by the remote control device is recognized by the remote control device that the DVD player successfully received and understood the most recently sent signal and that the command set from which the signal was selected is the correct command set with which to control operation of the DVD player. The remote control device records data identifying the correct command set and the remote control device is then ready for continued operation to control the DVD player.

From the user's perspective, programming of the remote control device is extremely simple and straight forward. The user places the DVD into the DVD player for playback in a television or other display device in a conventional manner. After a few seconds, a message appears on the television to press a particular button of the remote control device, which the user presses as instructed. A message then appears on the television that the remote control device is now successfully configured for use with the DVD player. The initial configuration of the remote control device is simple and requires no reference to user manuals or other written instructions which may become lost.

To more quickly determine the appropriate command set, the television can initially display a message instructing the user to identify the manufacturer of the DVD player on the remote control device and to wait patiently. The user selects the manufacturer using the remote control device and waits for further instructions to appear on the television. The remainder of the interaction is as described above.

### BRIEF DESCRIPTION OF THE DRAWINGS

FIG. 1 is a diagram illustrating a remote control device which performs initial configuration for use with a DVD player in accordance with the present invention.

FIG. 2 is a block diagram of the remote control device of FIG. 1 in greater detail.

FIG. 3 is a logic flow diagram illustrating the repeated attempted signaling of the DVD player by the remote control device of FIG. 1 in accordance with the present invention.

### DETAILED DESCRIPTION

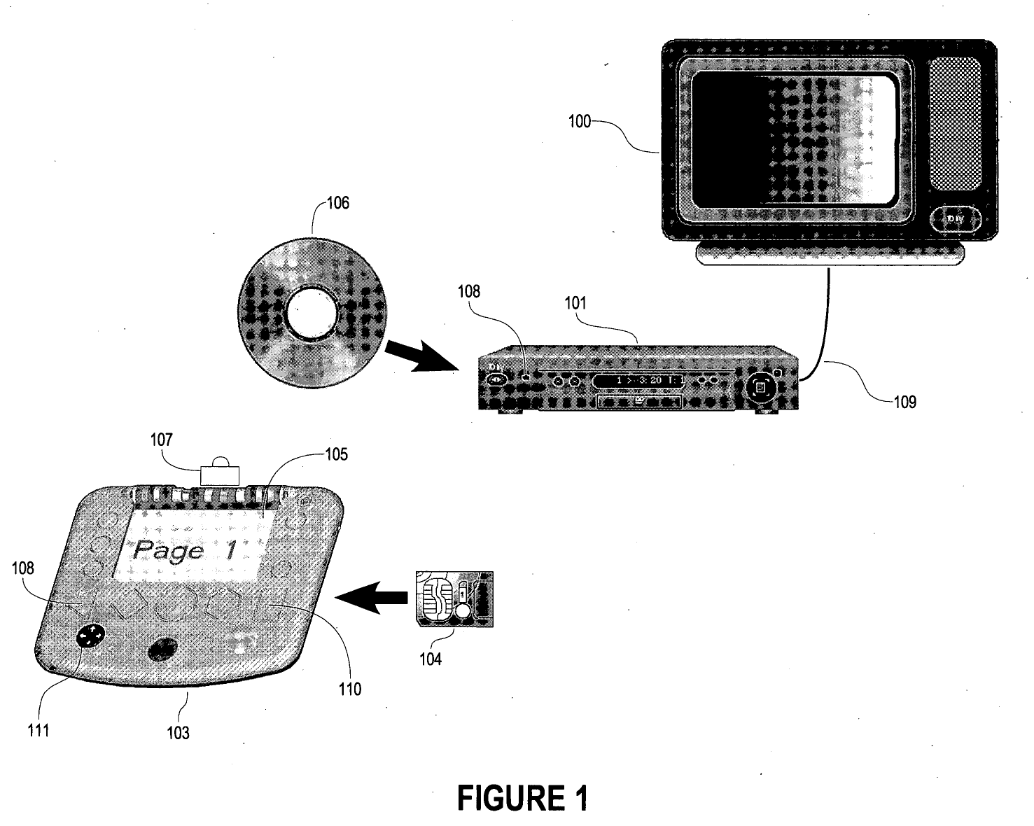

In accordance with the present invention, a remote control device 103 (FIG. 1) automatically cycles through a number of candidate program codes and uses a response of the user to visual cues displayed on television 100 to identify the correct program code. Remote control device 103 uses a specially authored DVD 106 to significantly simplify programming of remote control device 103. In particular, DVD 106 is configured to begin by displaying a blank screen or a screen with a “Please wait” message on television 100 and to have an invisible graphical user interface (GUI) button on which focus is placed. The button is made invisible by making the button identical to the background over which the button is displayed. Placing focus on the GUI button means that pressing an “Enter” key on a remote control will actuate the GUI button, i.e., will send a signal recognized by DVD player 101 as an enter command.

Remote control device 103 tries each of a number of candidate program codes, each of which corresponds to a set of commands which control a controlled device such as DVD player 101. For each program code, remote control device 103 issues an enter command selected from the set of commands associated with the program code. When remote control device 103 issues the enter command associated with the correct program code, DVD player 101 responds and actuates the invisible GUI button as if the user had manually pressed an “Enter” button on a conventional remote control. In response to actuation of the invisible GUI button, DVD 106 is configured to display a message that instructs the user to perform a user interface gesture on remote control device 103, such as pushing a specific button. The user input gesture in response to the displayed message acts as a feedback message through the user to the remote control device that the command was successfully received and understood by DVD player 101.

Remote control device 103 recognizes the pressed button as acknowledgment from the user that the correct program code has been selected by remote control device 103. Thus, the user simply inserts DVD 106 as she would any DVD for playback on television 100 and follows directions as controlled by remote control device 103 and played from DVD 106.

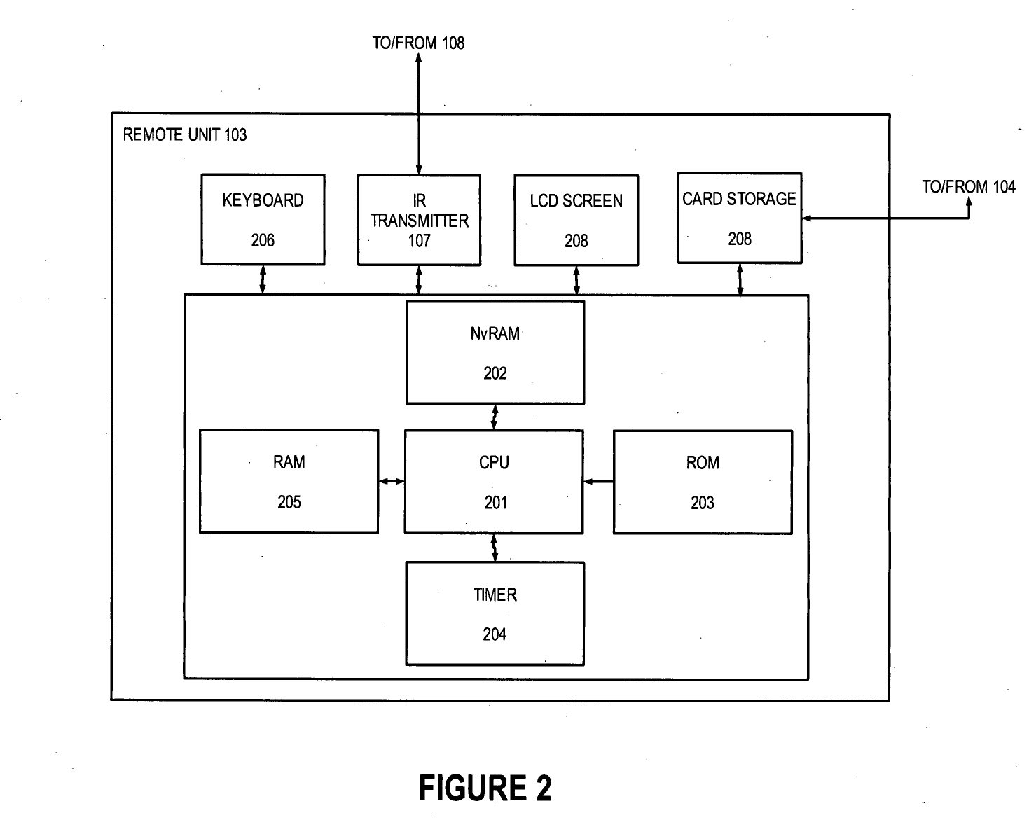

Remote control device 103 is analogous to a game controller device described more completely in co-pending and commonly-owned U.S. patent application Ser. No. 10/247,271 for “Portable Handheld Device for Enabling Interactivity of Video Content” by John Kavanagh filed Sept. 18, 2002 (hereinafter the “'271 Application”), and that description is incorporated herein by reference in its entirety. Remote control device 103 includes additional functionality, defined either in ROM 203 (FIG. 2) or in memory device 104. Memory device 104 is removable and can be, for example, any currently available flash memory device.

As described in the '271 Application, the behavior of remote control device 103 can be controlled by computer instructions and data stored in memory device 104. In this illustrative embodiment, memory device 104 corresponds to DVD 106 and are provided to the user of remote control device 103 together as a configuration kit for remote control device 103. In an alternative embodiment, the behavior of remote control device 103 is controlled by computer instructions and data stored within ROM 203 and/or NvRAM 202 and DVD 106 is provided with remote control device 103, obviating memory device 104 for initial configuration of remote control device 103. For clarity, it is described hereinafter that the behavior of remote control device 103 is defined within memory device 104, but it should be understood that the same behavior can alternatively be specified within NvRAM 202 and/or ROM 203.

DVD 106 is specific to the initial configuration behavior of remote control device 103 as defined by memory device 104. In a preferred embodiment, the user identifies the manufacturer of DVD player 101 to speed up the initial configuration process considerably. In this preferred embodiment, DVD 106 is configured to instruct the user to specify the manufacturer of DVD player 101. For example, the initial chapter of DVD 106 when displayed on television 100 by DVD player 101 instructs the user to “Please select the manufacturer of your DVD player” using remote control device 103. It is helpful if the message also informs the user that programming may take a few minutes and that the user should be patient. At this point, remote control device 103 probably cannot communicate with DVD player 101 and is at least not known to be able to communicate with DVD player 101.

Remote control device 103 can be configured to receive identification of the manufacturer of DVD player 101 from the user in a number of ways. In one embodiment, remote control device 103 includes a touch-sensitive display 105 on which a number of manufacturers are identified. The user can simply touch touch-sensitive display 105 at the location of the identifier of the appropriate manufacturer. In another embodiment, the user can select the appropriate manufacturer from a list displayed in touch-sensitive display 105 using a multi-direction button 106. In this alternative embodiment, touch-sensitive display 105 can be replaced with an ordinary display which is not touch-sensitive. In yet another embodiment, touch-sensitive display 105 is replaced with a touch-sensitive pad and an overlay onto which manufacturers of DVD players are printed in predetermined locations recognized by logic within remote control device 103. Of course, other ways to specify a DVD player manufacturer can be used within remote control device 103 such as speech and/or handwriting recognition—limited only by the processing and interaction capabilities of remote control device 103.

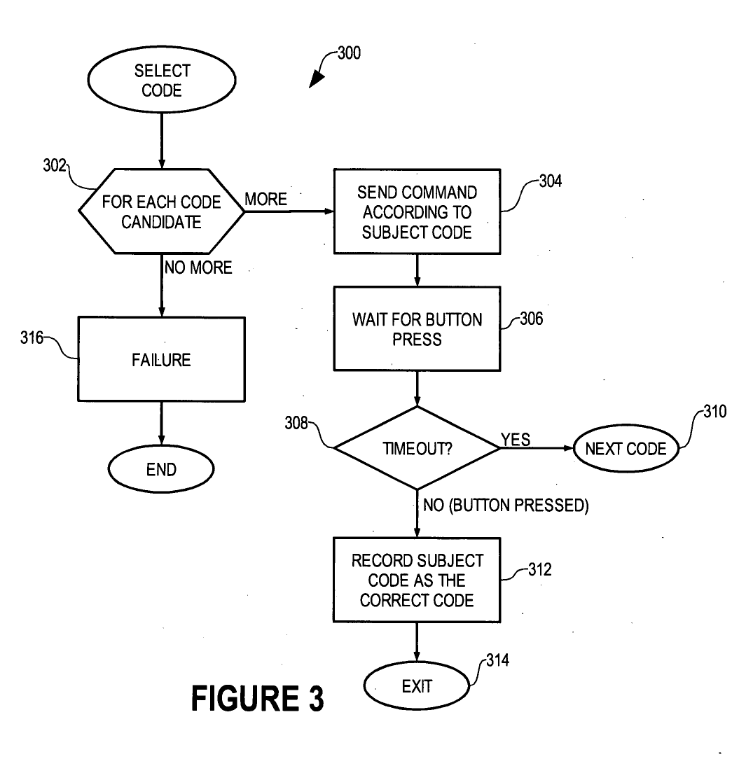

Once the manufacturer of DVD player 101 is known by remote control device 103, the list of possible program codes is limited to a relatively manageable number, e.g., as little as one or as many as about twenty. These possible program codes of the selected manufacturer are sometimes referred to herein as candidate codes. The candidate codes are processed by remote control device 103 in a manner illustrated by logic flow diagram 300 (FIG. 3).

In an alternative embodiment, specification of the manufacturer of DVD player 101 is skipped and all possible codes of all models of DVD players by all manufacturers are included in the candidate codes. Despite there being many manufacturers of DVD players, each of which can use as many as twenty (20) unique command sets, there are currently only about thirty (30) unique command sets. So, omitting specification of the manufacturer significantly simplifies automated programming in accordance with the present invention without adding excessive inefficiency in the automated programming, relative to having the manufacturer specified by the user. In this alternative embodiment, the initial chapter does not instruct the user to specify the manufacturer of DVD player 101 but rather instructs the user to wait patiently while the remote control device is automatically programmed.

Loop step 302 and next step 310 define a loop in which each of the candidate codes is processed according to steps 304-308. During each iteration of the loop of steps 302-310, the particular candidate code processed by remote control device 103 is sometimes referred to as the subject code.

In step 304, remote control device 103 sends a predetermined command according to the subject code. As described above, the initially displayed video content of DVD 106 includes an invisible GUI button on which focus is placed. Alternatively, the GUI button can be visible. However, it is preferred that the user is not prompted to take action at this point since the user is not expected to interact directly with DVD player 101. In this embodiment, the initially displayed video content is the screen which instructs the user to select the manufacturer of DVD player 101. Thus, from the perspective of DVD player 101, a video loop and/or static image is displayed on television 100 and a single GUI button is displayed. An enter command, e.g., sent by pressing an “Enter” button on a conventional remote control device, would actuate that displayed GUI button. Accordingly, in step 304, remote control device 103 sends such an enter command according to the subject code, e.g., from a remote control infrared command set associated with the subject code.

If the subject code is not the appropriate code for DVD player 101, sending of the command in step 304 has no effect on DVD player 101 and the user continues to the see the display screen instructing the user to patiently wait. Conversely, if the subject code is the appropriate code for DVD player 101, the invisible GUI button is actuated and corresponding video content of DVD 106 is displayed by DVD player 101 on television 100. In this illustrative embodiment, such corresponding video content informs the user that the initial configuration process is nearly complete and instructs the user to perform a predetermined user input gesture on remote control device 103. For example, the predetermined user input gesture can be the pressing of button 108.

In step 306, remote control device 103 waits a predetermined period of time for the user to press button 108. Processing transfers from step 306 to test step 308 if the user presses button 108 or if the predetermined period of time elapses, causing a timeout condition.

In test step 308, remote control device 103 determines whether a timeout condition was trapped from step 306. If so, remote control device 103 determines that the user did not see an instruction to press button 108 and therefore determines that the subject code is not the appropriate code for DVD player 101 and processing transfers through next step 310 to loop step 302 in which the next candidate code is processed according to the loop of steps 302-310.

Conversely, if a timeout condition was not trapped, remote control device 103 determines that the user did press button 108 and therefore saw an instruction to press button 108. Accordingly, remote control device 103 determines that the subject code is the appropriate code for DVD player 101. Remote control device 103 therefore transfers to step 312 in which remote control device 103 records the subject code in NvRAM 202 as the code according to which to send commands to DVD player 101. It is preferred that the code, once determined, is recorded in non-volatile memory such as NvRAM 202 such that the code is retained despite loss of power to remote control device 103. After step 312, processing according to logic flow diagram 300 completes and the code selection process as implemented by remote control device 103 completes.

If the user never performs the predetermined user input gesture, remote control device 103 processes all candidate codes according to the loop of steps 302-310 without ever reaching step 312. After all candidate codes have been so processed by remote control device 103, processing transfers from loop step 302 to step 316 in which a failure of the initial configuration is detected by remote control device 103. Such a failure can be handled in any of a number of ways. In this illustrative embodiment, remote control device 103 displays a message in touch-sensitive display 105 that initial configuration has failed and that the use should restart initial configuration by removing and re-inserting DVD 106 from and into DVD player 101.

After processing according to logic flow diagram 300, remote control device 103 uses the determined code to select the correct set of IR codes with which DVD player 101 can now be controlled. Remote control device 103 is thus properly programmed within the user doing no more than inserting DVD 106 and memory device 104 and following instructions displayed on television 100.

To signal completion of the programming to the user, remote control device 103 sends IR control signals to DVD player 101 to cause display of a success message from DVD 106 onto television 100.

As described above, remote control device 103 waits a predetermined amount of time for user response in step 306. The predetermined amount of time should be selected such that the user has ample time to follow the displayed instructions and perform the predetermined user input gesture and that remote control device 103 can process as many as twenty candidate codes in a reasonable amount of time. In this illustrative embodiment, the predetermined amount of time is three (3) seconds. Such gives the user a reasonable amount of time to perform the predetermined user input gesture when so instructed by a message displayed by television 100 and allows remote control device 103 to process twenty candidate codes for a pre-selected manufacturer in about sixty (60) seconds—or thirty (30) candidate codes for all models of DVD players in about ninety (90) seconds.

It should be appreciated that it's possible that the user will inadvertently miss the displayed instruction to perform the predetermined user input gesture such that remote control device 103 misses identification of the correct code for control of DVD player 101. In this illustrative embodiment, such is detected as follows. The video clip of DVD 106 displayed in response to the enter command sent by remote control device 103 in step 304 begins as described above, with an instruction to perform the predetermined user input gesture, e.g., to press button 108. The video clip displays that instruction for the predetermined period of time, e.g., three (3) seconds, after which time the video clip displays a different instruction. The different instruction is to perform a second, different user input gesture such as pressing button 110. Thus, if the user steps away to answer the phone or for some other distraction during processing according to logic flow diagram 300 and one of the candidate codes did in fact successfully command DVD player 101, the user will return to a message on television 100 to press button 110.

In response to the second user input gesture, remote control device 103 repeats processing according to logic flow diagram 300, giving the user another chance to respond within the predetermined period of time. In some embodiments, the predetermined period of time is lengthened each time the second user input gesture is detected to give the user more time to respond in successive attempts.

In another embodiment, remote control device 103 responds to the second user input gesture by repeating the loop of steps 302-310 for only those candidate code already processed according to steps 302-310 and in reverse order. Remote control device 103 interprets the second user input gesture as an indication that the proper code has already been transmitted, thus eliminating candidates codes which have not yet been tried as potentially proper codes. It is assumed that, if the user is distracted sufficiently to miss the properly operative code, such will not happen right away but instead after waiting a while. By processing most recently tried candidate codes first, it is believed that the user will have to wait a shorter amount of time for the proper code to be tried again—thus, enhancing efficiency of recovery from a missed proper code.

Thus, from the user's perspective, DVD 106 is placed into DVD player 101 for playback in television 100 in a conventional manner. Television 100 displays a message instructing the user to wait patiently. After a few seconds, a message appears on television 100 to press button 108, which the user presses as instructed. A message then appears on television 100 that remote control device 103 is now successfully configured for use with DVD player 101. The initial configuration of remote control device 103 is simple and requires no reference to user manuals or other written instruction which may become lost. In addition, if DVD player 101 is ever replaced with a different model and/or make of DVD player, the initial configuration can be repeated in the manner described above to re-program remote control device 103 for use with the new DVD player.

The above description is illustrative only and is not limiting. Instead, the present invention is defined solely by the claims which follow and their full range of equivalents.

What is claimed is:

1. A method for identifying which of a number of command sets is an operative command set to which an external device is responsive, the method comprising:
for each of one or more of the command sets:
sending a signal to the external device wherein the signal is selected according to the command set to cause the external device to instruct a user to perform a user input gesture;
determining that the command set is the operative command set upon a condition in which performance of the user input gesture is detected.

2. The method of claim 1 wherein the external device is a DVD player.

3. The method of claim 2 wherein sending and determining are performed by a remote control device to thereby program the remote control device to control operation of the DVD player.

4. The method of claim 1 wherein each of the command sets is a collection of remote signals to control operation of one or more types of external devices.

5. The method of claim 1 wherein the signal is an infrared signal.

6. The method of claim 1 wherein the signal is selected to cause the external device to instruct the user by causing the external device to display predetermined content from a removable storage medium wherein the predetermined content includes instruction to the user to perform the user input gesture.

7. The method of claim 1 wherein the user input gesture is the pressing of a button on a remote control device which is separate from the external device.

8. The method of claim 1 further comprising:
recording data identifying the operative command set in non-volatile memory.

9. The method of claim 1 further comprising:
for each of the one or more of the command sets:
waiting a predetermined period of time after the sending of the signal for the user to perform the user input gesture.

10. The method of claim 9 further comprising:
for each of the one or more of the command sets:
determining that the command set is not the operative command set upon a condition in which the user input gesture is not detected within the predetermined period of time.

11. A device readable medium useful in association with a remote control device which includes a processor and a memory, the device readable medium including instructions which are configured to cause the remote control device to identify which of a number of command sets is an operative command set to which an external device is responsive by:
for each of one or more of the command sets:
sending a signal to the external device wherein the signal is selected according to the command set to cause the external device to instruct a user to perform a user input gesture;
determining that the command set is the operative command set upon a condition in which performance of the user input gesture is detected.

12. The device readable medium of claim 11 wherein the external device is a DVD player.

13. The device readable medium of claim 12 wherein sending and determining are performed by a remote control device to thereby program the remote control device to control operation of the DVD player.

14. The device readable medium of claim 11 wherein each of the command sets is a collection of remote signals to control operation of one or more types of external devices.

15. The device readable medium of claim 11 wherein the signal is an infrared signal.

16. The device readable medium of claim 11 wherein the signal is selected to cause the external device to instruct the user by causing the external device to display predetermined content from a removable storage medium wherein the predetermined content includes instruction to the user to perform the user input gesture.

17. The device readable medium of claim 11 wherein the user input gesture is the pressing of a button on a remote control device which is separate from the external device.

18. The device readable medium of claim 11 wherein the instructions are configured to cause the remote control device to identify which of a number of command sets is an operative command set to which an external device is responsive by also:
recording data identifying the operative command set in non-volatile memory.

19. The device readable medium of claim 11 wherein the instructions are configured to cause the remote control device to identify which of a number of command sets is an operative command set to which an external device is responsive by also:
for each of the one or more of the command sets:
waiting a predetermined period of time after the sending of the signal for the user to perform the user input gesture.

20. The device readable medium of claim 19 wherein the instructions are configured to cause the remote control device to identify which of a number of command sets is an operative command set to which an external device is responsive by also:
for each of the one or more of the command sets:
determining that the command set is not the operative command set upon a condition in which the user input gesture is not detected within the predetermined period of time.

21. A remote control device that is configured to identify which of a number of command sets is an operative command set to which an external device is responsive by:
for each of one or more of the command sets:
sending a signal to the external device wherein the signal is selected according to the command set to cause the external device to instruct a user to perform a user input gesture;
determining that the command set is the operative command set upon a condition in which performance of the user input gesture is detected.

22. The remote control device of claim 21 wherein the external device is a DVD player.

23. The remote control device of claim 22 wherein sending and determining are performed by a remote control device to thereby program the remote control device to control operation of the DVD player.

24. The remote control device of claim 21 wherein each of the command sets is a collection of remote signals to control operation of one or more types of external devices.

25. The remote control device of claim 21 wherein the signal is an infrared signal.

26. The remote control device of claim 21 wherein the signal is selected to cause the external device to instruct the user by causing the external device to display predetermined content from a removable storage medium wherein the predetermined content includes instruction to the user to perform the user input gesture.

27. The remote control device of claim 21 wherein the user input gesture is the pressing of a button on a remote control device which is separate from the external device.

28. The remote control device of claim 21 wherein the remote control device is configured to identify which of a number of command sets is an operative command set to which an external device is responsive by also:
recording data identifying the operative command set in non-volatile memory.

29. The remote control device of claim 21 wherein the remote control device is configured to identify which of a number of command sets is an operative command set to which an external device is responsive by also:
for each of the one or more of the command sets:
waiting a predetermined period of time after the sending of the signal for the user to perform the user input gesture.

30. The remote control device of claim 29 wherein the remote control device is configured to identify which of a number of command sets is an operative command set to which an external device is responsive by also:
for each of the one or more of the command sets:
determining that the command set is not the operative command set upon a condition in which the user input gesture is not detected within the predetermined period of time.
